(19) United States
(12) Patent Application Publication
(10) Pub. No.: US 2008/0038173 A1
(43) Pub. Date: Feb. 14, 2008

(54) System and process for cleaning a flue gas stream

(75) Inventors: Keith M. Bradburn, Knoxville, TN (US); Philip C. Rader, Knoxville, TN (US); Michael G. Varner, Knoxville, TN (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(73) Assignee: Alstom Technology Ltd, a company of Switzerland

(21) Appl. No.: 11/503,437

(22) Filed: Aug. 11, 2006

(51) Int. Cl. B01D 39/00

(52) U.S. Cl. 423/215.5

(57) ABSTRACT

A process for cleaning a flue gas stream (10) in a flue gas cleaning system (2) to remove contaminants such as particulates and acidic components therefrom. The process includes admitting the flue gas stream to a particle collection device (18) to deposit the contaminants onto collector surfaces (19) therein, contacting the collector surfaces (19) with a wash water (20) to remove the contaminants therefrom, and discharging the wash water from the particle collection device (18) to a position downstream of the particle collection device (18). The discharged wash water is neutralized and circulated within the flue gas cleaning system (2).

### BACKGROUND OF THE INVENTION

1. Field of the Invention

The present invention relates to a system and method for cleaning a flue gas stream to remove contaminants, and more particularly to a system and process for cleaning a flue gas stream in which a wet electrostatic precipitator (ESP) is employed.

2. Description of the Related Art

Laws and regulations governing air quality continue to focus on small particle emissions, such as particulate matter less than 2.5 microns in diameter as well as acid mist emissions from utility coal-fired power stations. Even moderate concentrations of acid mist, e.g., H₂SO₄, in a flue gas stream generated by combustion of coal may cause problems in the downstream equipment, such as corrosion of fans, flues, internal support structures, and other equipment exposed to the acid mist. Additionally, human or animal exposure to acid mist and other small particle emissions is a health and safety concern.

One known approach to effectively capture the small particle emissions and acid mist from a flue gas stream is the use of a wet electrostatic precipitator (ESP). Wet ESPs are commonly installed downstream of a wet flue gas desulfurization (WFGD) system as a “polishing unit” for the small amount of fine particles and sulfur trioxide (SO₃) mist in the flue gas that escapes removal in the WFGD. Specifically, a wet ESP can be mounted directly on top of the WFGD absorber (i.e. vertical flow configuration) or installed downstream of the absorber (i.e. horizontal or vertical flow configuration).

A wet ESP includes a system of grounded collector plate surfaces forming passages with discharge electrodes located between the collector surfaces. Flue gas that contains small particulates, acid mist, and moisture droplets, among other compounds, is passed between the collector surfaces. A negative voltage is applied to the discharge electrodes creating an electrical field. At a certain potential, corona discharge occurs and negative ions are generated which migrate toward the collector surface. As they pass across the inter-electrode space, charges are imparted to the small particles and moisture droplets in the flue gas. The small particles, acid mist droplets and moisture droplets then move under the electric field to the collector surface where they are deposited. The collected small particles and droplets are then flushed down the collector surfaces to the precipitator bottom by spraying or irrigating with water.

There are numerous variations to the design of a wet ESP. However, common features among all designs include the washing of electrodes and collector plates and the exposure of internal surfaces to acid mist. The water that is used to spray the collector plates and electrodes, known as wash water, keeps the devices and surfaces clean, which allows optimal performance of the wet ESP. This water is collected regardless of the wet ESP's vertical or horizontal orientation or system-specific design.

The discharged wash water contains high levels of acidic ions, which result in extremely low pH levels (below 1.0 in some cases). Such acidic wash water is highly corrosive. To prevent damage to internal equipment of the wet ESP from this highly acidic wash water, the equipment needs to be built of high-grade alloys that will not deteriorate rapidly when exposed to the corrosive wash water, or alternatively, there needs to be a high wash rate to keep the acid diluted. Both of these solutions may greatly increase capital and operation costs of the power plant.

### BRIEF SUMMARY OF THE INVENTION

One aspect of the present invention relates to a process for cleaning a flue gas stream in a flue gas cleaning system to remove contaminants comprising particulates and acidic components therefrom, the process including: admitting the flue gas stream to a particle collection device to deposit the contaminants onto collector surfaces therein; contacting the collector surfaces with a wash water to remove the contaminants therefrom; discharging the wash water from the particle collection device to a position downstream of the particle collection device, wherein the wash water contains the contaminants and is acidified thereby; neutralizing the discharged wash water containing the contaminants to form a neutralized wash water; and circulating the neutralized wash water within the flue gas cleaning system.

Another aspect of the present invention relates to a system for cleaning a flue gas stream to remove contaminants comprising particulates and acidic components therefrom, comprising: a particle collection device for receiving the flue gas and for depositing the contaminants onto collector surfaces therein; conduit means for admitting a wash water to the particle collection device for contacting the collector surfaces and thereby removing the contaminants therefrom; conduit means for discharging from the wash water from the particle collection device, wherein the wash water contains the contaminants and is acidified thereby; neutralizing means for neutralizing the discharged wash water containing the contaminants; and circulating means for circulating the neutralized wash water within the system.

A further aspect of the present invention relates to a system for circulating and treating a wash water in a flue gas stream cleaning system, comprising: a particle collection device comprising collector surfaces, wherein contaminants from a flue gas stream are deposited on the collector surfaces; a wash water for contacting the collector surfaces and removing the contaminants therefrom, wherein the wash water is acidified thereby; means for discharging the acidified wash water from the collector surfaces to a recirculation tank; means for neutralizing the acidified wash water in the recirculation tank to form a neutralized wash water; and means for circulating the neutralized wash water to a location within the flue gas cleaning system, the location selected from a group consisting of the particle collection device and a position upstream of the particle collection device.

### BRIEF DESCRIPTION OF THE DRAWINGS

For the purpose of illustrating the invention, the drawings show a form of the invention that is presently preferred. However it should be understood that the present invention is not limited to the precise arrangements and instrumentalities shown in the drawings, wherein:

FIG. 1 is a schematic view of a system according to one embodiment of the present invention;

FIG. 2 is a schematic view of a system according to one embodiment of the present invention; and

FIG. 3 is a flowchart of a process according to one embodiment of the present invention.

### DETAILED DESCRIPTION

The present invention includes a process and system for cleaning a flue gas stream produced by a combuster, e.g., a boiler. The process also includes neutralizing and circulating wash water discharged from a particle collection device, which is operatively connected to a WFGD system.

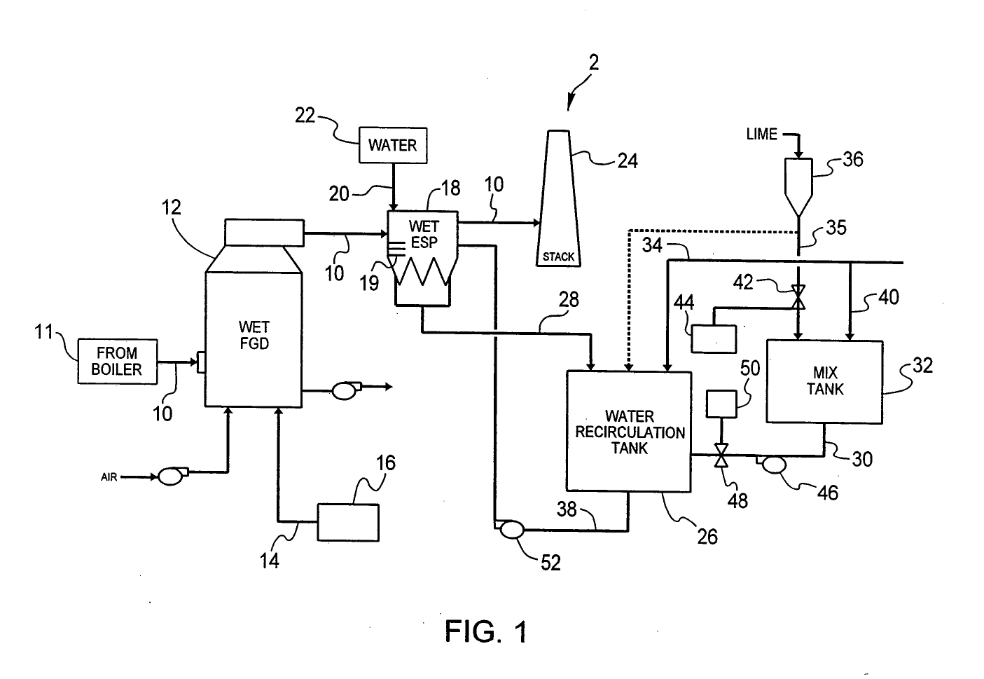

Referring now to FIGS. 1-3, and in particular to FIG. 1, one embodiment of the present invention includes a flue gas stream cleaning system and process 2. A flue gas stream 10 is released from a boiler 11 and travels to a WFGD system 12. WFGD system 12 employs an aqueous alkaline slurry 14 for the removal of contaminants, particularly sulfur dioxide, from flue gas stream 10. Aqueous alkaline slurry 14 is typically transported to WFGD system 12 from a tank 16. While FIG. 1 shows aqueous alkaline slurry 14 and tank 16 located in one position, it is contemplated that the slurry and the tank can be located at any position that allows the slurry to be introduced to WFGD system 12.

Flue gas stream 10 also travels through a particle collection device 18 that removes particles from the flue gas stream by using electric forces. Particle collection device 18 is typically a wet electrostatic precipitator (wet ESP), which is a self-washing, self-cleaning device that utilizes a liquid, referred to as “wash water,” to clean the collector surfaces 19 and other internal structures of the wet ESP. In most systems, the wash water is added as fresh wash water 20, which is added to particle collection device 18 via a conduit, such as pipework, that connects a water holding tank 22 to the particle collection device.

Particle collection device 18 is in fluid communication with a stack 24, which emits flue gas stream 10 into the atmosphere. Particle collection device 18 is also in fluid communication with a water recirculation tank 26.

Typically, water recirculation tank 26 is downstream of particle collection device 18 and is in communication with the particle collection device either by means of ducts or pipes made of metal or any other material that permits an acidified wash water 28 to flow from the particle collection device to the water recirculation tank. Acidified wash water 28 is the resulting liquid that was used to clean collecting surfaces 19 and internal structures of particle collection device 18. Acidified wash water 28 typically contains water, gypsum particles, fly ash particles, chloride ions and other constituents typically found in treated or fresh water supply sources.

Prior to, or upon entering water recirculation tank 26, the pH of acidified wash water 28 may be measured. Since acidified wash water 28 is neutralized by a neutralizing material 30 in water recirculation tank 26, measurement of the pH will allow for a more effective neutralization of the acidified wash water.

As shown in FIG. 1, neutralizing material 30 is typically discharged from a mix tank 32 and added to water recirculation tank 26. A fresh water 34 may also be added to water recirculation tank 26. The combination of acidified wash water 28, neutralizing material 30, and fresh water 34 form a neutralized wash water 38.

Neutralizing material 30 is made in mix tank 32 and typically contains an alkaline material 35 and a water 40. Alkaline material 35 may be any alkaline material such as lime, limestone, magnesium, sodium, or a mixture thereof. Alkaline material 35 may be in any form suitable for use in a flue gas stream cleaning system. For example, alkaline material 35 may be in the form of a powder. Typically, alkaline material 35 is discharged from a neutralizing material tank 36 and combined with water 40 in mix tank 32, thereby forming neutralizing material 30. Neutralizing material 30 neutralizes, i.e., increases the pH, of the acidified wash water 28. Alternatively, as indicated by the dashed line in FIG. 1, alkaline material 35 can be added directly to water recirculation tank 26, along with water 34. In this embodiment, acidified wash water 28 is neutralized by the direct addition of alkaline material 35 to the acidified wash water present in water recirculation tank 26.

The basic ions in alkaline material 35 or neutralizing material 30, will combine with acidic species present in acidified wash water 28, such as: sulphuric acid, sulphurous acid, hydrochloric acid, and hydrofluoric acid to form stable, water-soluble compounds.

Still referring to FIG. 1, a control device 42 may be placed between neutralizing material tank 36 and mix tank 32 to control the amount of alkaline material 35 transported to the mix tank. Additionally, a monitoring device 44 may be placed between mix tank 32 and neutralizing material tank 36 which would allow a user to monitor the amount of alkaline material 35 transported to the mix tank. Monitoring device 44 may be a meter, a computer or any other instrument that allows a user to monitor the amount of alkaline material 35. After combining alkaline material 35 and water 40 in mix tank 32 to produce neutralizing material 30, the neutralizing material is transported to water recirculation tank 26 by a pump 46.

Neutralizing material 30 is typically added to water recirculation tank 26 on a continuous basis in an amount effective to achieve a neutral or slightly acidic (i.e., between about 5-7 pH) wash water 38 in the water recirculation tank.

A control valve 48 or other control device such as a valve, gauge, lever, and the like, may be arranged between mix tank 32 and water recirculation tank 26. The control valve may be connected to a pH instrument located within water recirculation tank 26. Optionally, a monitoring device 50 may also be placed between mix tank 32 and water recirculation tank 26 to allow a user to monitor the amount of a neutralization material 30 sent to the recirculation tank.

Monitoring device 50 allows a user to monitor the amount of neutralizing material 30 transported to water recirculation tank 26. Monitoring device 50 may be a meter, a computer or any other instrument that allows a user to monitor the amount of neutralizing material 30.

Still referring to FIG. 1, water recirculation tank 26 is also fluidly connected to particle collection device 18 in a manner that allows neutralized wash water 38 to be circulated back to the particle collection device. Neutralized wash water 38 is transported by pump 52 to particle collection device 18. Neutralized wash water 38 washes over collector surfaces 19 and other internal structures (not shown) of particle collection device 18 and is discharged from the particle collection device as acidified wash water 28. Acidified wash water 28 follows the process stream as discussed previously.

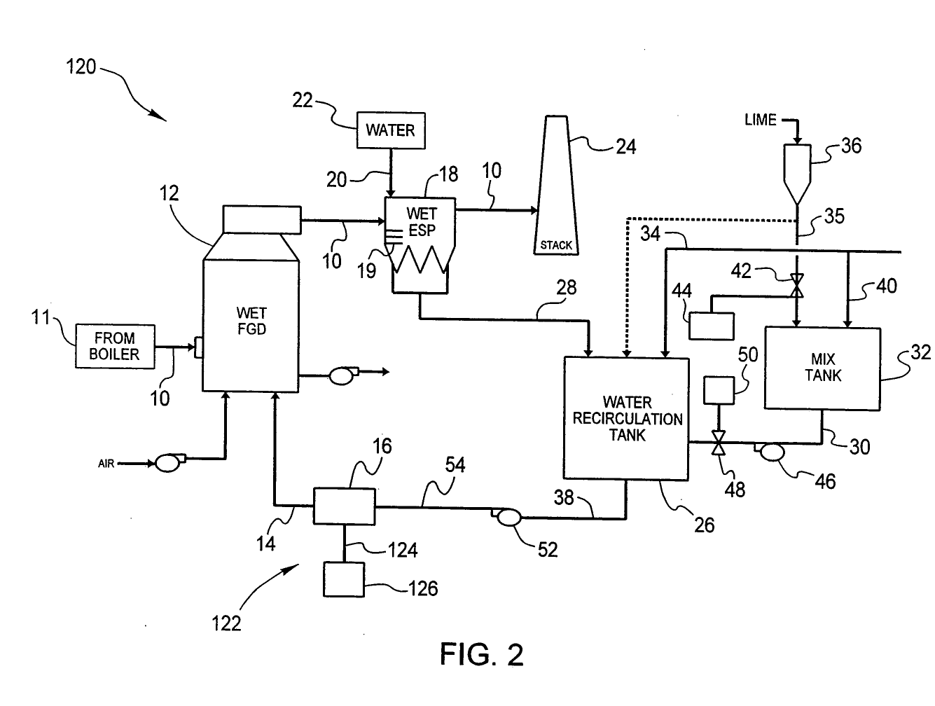

Referring now to FIG. 2, another embodiment of the present invention includes a system and process 120. With the exception of the differences described below, system and process 120 is substantially similar to or identical to the process described above as indicated by similar or identical element numbers. As in the description of the process described in FIG. 1, with respect to system and process 120, flue gas stream 10 refers generally to any flue gas and the particular constituents that make up the flue gas are expected to vary as the flue gas is treated.

One way system and process 120 differs from system and process 2 of FIG. 1 is that neutralized wash water 38 is circulated to any location within system 120 instead of circulated to particle collection device 18. Neutralized wash water 38 can be circulated to any place upstream of particle collection device 18, such as to a reagent preparation system 122 or directly to an absorber reaction tank of WFGD system 12. Neutralized wash water 38 may also be circulated to a gypsum dewatering area (not shown).

Still referring to FIG. 2, neutralized wash water 38 may be sent via a conduit 54 to reagent preparation system 122. Reagent preparation system 122 includes tank 16. In tank 16, neutralized wash water 38 is mixed with an alkaline material 124 from a tank 126 to form aqueous alkaline slurry 14. Aqueous alkaline slurry 14 is then transported to WFGD system 12 to facilitate the removal of contaminants from flue gas stream 10.

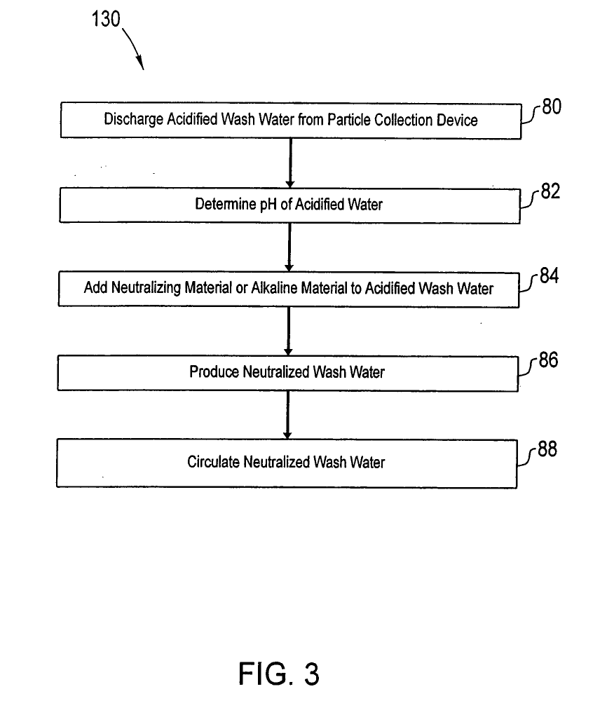

Now referring to FIG. 3, one embodiment of the present invention is a process 130 for cleaning a flue gas stream in a flue gas cleaning system. As shown in step 80, acidified wash water 28 is discharged from particle collection device 18 to water recirculation tank 26.

Next, at step 82, the pH of acidified wash water 28 may be measured. Measurement of the pH can occur anytime after the acidified wash water has passed through particle collection device 18. Here, it is shown that the measurement occurs after wash water 28 has been discharged from particle collection device 18.

After the pH has been measured, neutralizing material 30 or alkaline material 35 is added to acidified wash water 28 in step 84. Addition of neutralizing material 30 or alkaline material 35 neutralizes at least a portion of acidified wash water 28. Typically, the amount of neutralizing material 30 or alkaline material 35 added to acidified wash water 28 is effective to neutralize most of the acid present in the acidified wash water.

Then, in step 86, neutralized wash water 38 is produced after the neutralizing material 30 or alkaline material 35 is added to acidified wash water 28. Next, as shown in step 88, neutralized wash water 38 may then be circulated to various locations throughout flue gas cleaning systems 2 and 120.

Systems 2 and 120 allow water purged from the flue gas cleaning system to come from one source, namely a discharge stream from particle collection device 18. Accordingly, the interface between the plant's waste water treatment plant and the wet ESP/WFGD systems is simplified since only one feed line would be required between the systems.

The neutralization of the acidic wash water is important to reduce cost of the internal equipment used in a particle collection device such as a wet ESP. Generally, the overall structure and internal equipment of the wet ESP must be constructed of material resistant to the highly acidic conditions within the wet ESP. Typically these materials are higher grade alloys like C22 and C276, which are orders of magnitude more expensive than traditional carbon steel or even stainless steel. The present invention allows the wet ESP components, equipment, and surfaces exposed to the flue gas and wash water streams to be constructed of lower grade materials, with stainless steel being the most preferable choice. It has been found that the capital cost of the wet ESP can be reduced by a factor of three when the lower grade materials are used. However, the invention also contemplates retrofitting existing wet ESP systems with the mixing tank and recirculation tank to extend the life of the structures, equipment, and surfaces of the wet ESP systems.

The present invention offers advantages over prior art systems. For instance, the present invention is inexpensive, not time-consuming, and is easily retrofitted in already existing systems. Additionally, the present invention advantageously allows the control of dissolved and suspended solids sent to a waste water treatment plant. Instead of sending these solids to the waste water treatment plant where it is costly to remove them, the solids are removed via the wet FGD equipment (i.e., gypsum dewatering filters) at no additional expense.

As shown in FIGS. 1-3, the wash water introduced to particle collection device 18 can be neutralized and re-used within the flue gas stream cleaning system, thus avoiding discharging acidified wash water 28 into the environment or into a wastewater treatment plant.

One or more embodiments of the present invention have been described. Nevertheless, it will be understood that various modifications may be made without departing from the spirit and scope of the invention. Accordingly, other embodiments are within the scope of the following claims.

What is claimed is:

1. A process for cleaning a flue gas stream in a flue gas cleaning system to remove contaminants comprising particulates and acidic components therefrom, the process comprising:
admitting the flue gas stream to a particle collection device to deposit the contaminants onto collector surfaces therein;
contacting the collector surfaces with a wash water to remove the contaminants therefrom;
discharging the wash water from the particle collection device to a position downstream of the particle collection device, wherein the wash water contains the contaminants and is acidified thereby;
neutralizing the discharged wash water containing the contaminants to form a neutralized wash water; and
circulating the neutralized wash water within the flue gas cleaning system.

2. A process according to claim 1, wherein discharged wash water is neutralized by contacting the wash water with a neutralizing material.

3. A process according to claim 2, wherein the neutralizing material comprises an alkaline material and water.

4. A process according to claim 3 wherein the alkaline material is selected from a group consisting of lime, limestone, magnesium, sodium, and a mixture thereof.

5. A process according to claim 1, wherein discharged wash water is neutralized by contacting the wash water with an alkaline material.

6. A process according to claim 5, wherein the alkaline material is selected from a group consisting of lime, limestone, magnesium, sodium, and a mixture thereof.

7. A process according to claim 1, wherein in the circulation step, the neutralized wash water is transported to the particle collection device.

8. A process according to claim 1, wherein in the circulation step, the neutralized wash water is transported to a location in the flue gas cleaning system upstream of the particle collection device.

9. A process according to claim 1, wherein in the recirculation step, the neutralized wash water is transported to a reagent preparation system within the flue gas cleaning system.

10. A process according to claim 1, wherein the particle collection device is a wet electrostatic precipitator.

11. A process according to claim 1, further comprising:
determining a pH of the wash water after discharging the wash water from the particle collection device.

12. A system for cleaning a flue gas stream to remove contaminants comprising particulates and acidic components therefrom, comprising:
a particle collection device for receiving said flue gas and for depositing the contaminants onto collector surfaces therein;
conduit means for admitting a wash water to the particle collection device for contacting the collector surfaces and thereby removing the contaminants therefrom;
conduit means for discharging from the wash water from the particle collection device, wherein the wash water contains the contaminants and is acidified thereby;
neutralizing means for neutralizing the discharged wash water containing the contaminants; and
circulating means for circulating the neutralized wash water within the system.

13. A system according to claim 12, wherein said neutralizing means is a neutralizing material.

14. A system according to claim 13, wherein said neutralizing material comprises an alkaline material and water.

15. A system according to claim 14, wherein said alkaline material is selected from a group consisting of lime, limestone, magnesium, sodium, and a mixture thereof.

16. A system according to claim 12, wherein said particle collection device is a wet electrostatic precipitator.

17. A system for circulating and treating a wash water in a flue gas stream cleaning system, comprising:
a particle collection device comprising collector surfaces, wherein contaminants from a flue gas stream are deposited on the collector surfaces;
a wash water for contacting the collector surfaces and removing the contaminants therefrom, wherein the wash water is acidified thereby;
means for discharging the acidified wash water from the collector surfaces to a recirculation tank;
means for neutralizing the acidified wash water in the recirculation tank to form a neutralized wash water; and
means for circulating the neutralized wash water to a location within the flue gas cleaning system, the location selected from a group consisting of the particle collection device and a position upstream of the particle collection device.

18. A system according to claim 17, wherein said means for neutralizing said acidified wash water comprises an alkaline material.

19. A system according to clam 17, wherein said particle collection device comprises a wet electrostatic precipitator.
